(19) United States
(12) Patent Application Publication
(10) Pub. No.: US 2025/0306888 A1
(43) Pub. Date: Oct. 2, 2025

(54) NOTIFYING VIRTULIZATION GUESTS OF UPCOMING HOST SOFTWARE UPDATES

(71) Applicant: Amazon Technologies, Inc., Seattle, WA (US)

(72) Inventors: Aviv David GREENBERG, San Jose, CA (US); James M. LI, Sammamish, WA (US); Thomas Tarak Mathew VEPPUMTHARA, Berlin (DE); Edward Randall PINSKY, Snoqualmie, WA (US); Jeffrey Winston ROBERSON, Camas, WA (US); Ning WANG, Seattle, WA (US); Joel BAUMERT, Ellicott City, MD (US); Alexander David FELDMAN, Seattle, WA (US); Jeremy LOX-FOLSOM, Seattle, WA (US)

(21) Appl. No.: 18/621,952

(22) Filed: Mar. 29, 2024

(51) Int. Cl. G06F 8/65; G06F 9/455; G06F 9/54

(52) U.S. Cl. CPC G06F 8/65; G06F 9/45558; G06F 9/542; G06F 2009/45562

(57) ABSTRACT

Techniques for notifying virtualization guests of upcoming host software updates are described. An instance is executed in a host environment of a computer system, the host environment providing a virtualized environment for the instance to execute a software application. A host software application update for a host software application executed in the host environment is received, the host software application update to be applied at an update time. An upcoming host software update notification is provided to the software application executed in the virtualized environment, the upcoming host software update notification indicating the update time. The host software application is updated at or after the update time.

### BACKGROUND

Virtualization technologies such as virtual machines and containers enable the creation of isolated environments for running applications and workloads on a single physical machine. By abstracting hardware resources and providing these guest environments, virtualization enhances efficiency, flexibility, and scalability in computing.

Virtualization is an important technology underlying cloud computing. Cloud computing providers provide on-demand, managed computing resources to customers. Such computing resources (e.g., compute and storage capacity) are often provisioned from large pools of capacity installed in data centers. Customers can request computing resources from the “cloud,” and the cloud can provision compute resources to those customers.

### BRIEF DESCRIPTION OF DRAWINGS

Various examples in accordance with the present disclosure will be described with reference to the drawings, in which:

FIG. 1 is a diagram illustrating an environment for notifying virtualization guests of upcoming host software updates according to some examples.

FIG. 2 is a sequence diagram illustrating exemplary operations to notify virtualization guests of upcoming host software updates according to some examples.

FIG. 3 is a sequence diagram illustrating exemplary operations continuing from FIG. 2 according to some examples.

FIG. 4 is a sequence diagram illustrating exemplary operations continuing from FIG. 3 according to some examples.

FIG. 5 is a diagram illustrating various exemplary data structures according to some examples.

FIG. 6 is a flow diagram illustrating operations of a method for notifying virtualization guests of upcoming host software updates according to some examples.

FIG. 7 illustrates an example cloud provider network environment according to some examples.

FIG. 8 is a block diagram of an example cloud provider network that provides a storage service and a hardware virtualization service to customers according to some examples.

FIG. 9 is a block diagram illustrating an example computing device that can be used in some examples.

### DETAILED DESCRIPTION

The present disclosure relates to methods, apparatus, systems, and non-transitory computer-readable storage media for notifying virtualization guests of upcoming host software updates. According to some examples, software executing in a “guest” virtualized environment provided by an instance such as a virtual machine or container is sent one or more notifications of upcoming software updates to the underlying host computer system. Virtualization is a technique used to share the capacity of a host computer system between several guests, commonly used in cloud computing. Cloud provider networks offering various services commonly rely on virtualization to better share the underlying fleet of host computer systems amongst their customers. Ongoing fleet maintenance operations often include deploying software updates to hosts while they are hosting guests (sometimes referred to as “live updates”). Some of these updates can cause momentary disruptions in performance, especially when those updates impact software that manages hardware access for the guest environments. For example, requests that are normally fulfilled in nanoseconds might take over a microsecond during an update. Guest applications can be sensitive to such performance-impacting events. When they occur, guest software may trigger unwarranted or unnecessary corrective actions or warnings. At the same time, the virtualization layer supporting instances is used to hide the software and hardware of the host computer system from these guest environments. As a consequence, updates to the underlying host systems can cause performance disruptions that are unpredictable yet perceptible to software executing in guest environments. The techniques described herein pass notifications of upcoming host software updates, such as those that may result in performance events, through the virtualization layer to guest environments. By doing so, customer software is able to act (or not act) more intelligently in response to these events.

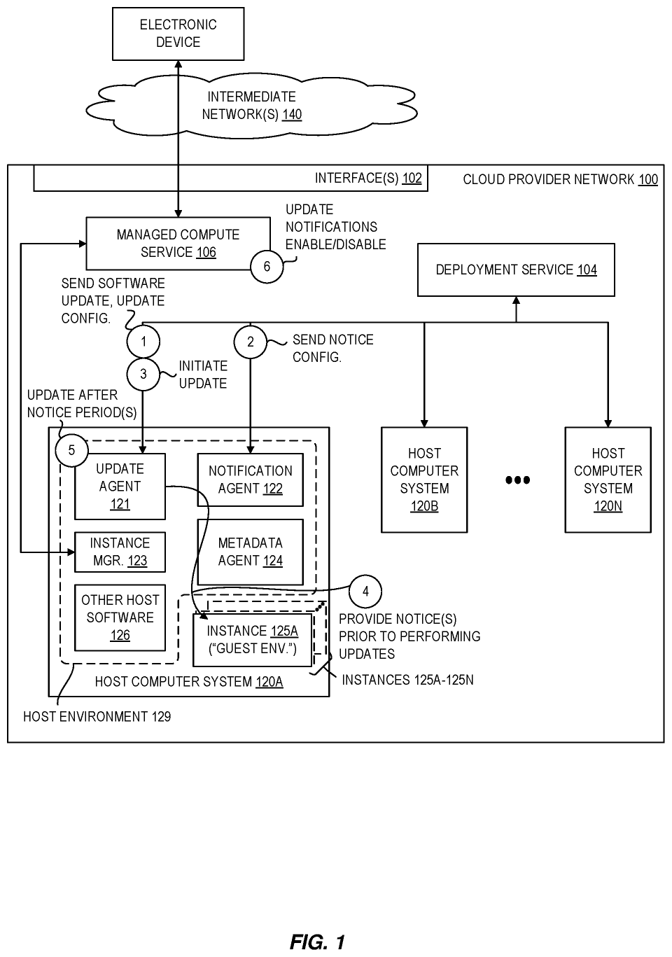

FIG. 1 is a diagram illustrating an environment for notifying virtualization guests of upcoming host software updates according to some examples. A cloud provider network 100 (also referred to herein as a provider network, service provider network, etc.) provides users with the ability to use one or more of a variety of types of computing-related resources such as compute resources (e.g., executing virtual machine (VM) instances and/or containers, executing batch jobs, executing code without provisioning servers), data/storage resources (e.g., object storage, block-level storage, data archival storage, databases and database tables, etc.), network-related resources (e.g., configuring virtual networks including groups of compute resources, content delivery networks (CDNs), Domain Name Service (DNS)), application resources (e.g., databases, application build/deployment services), access policies or roles, identity policies or roles, machine images, routers and other data processing resources, etc. These and other computing resources can be provided as services, such as a hardware virtualization service that can execute compute instances, a storage service that can store data objects, etc. The users (or “customers”) of cloud provider networks 100 can use one or more user accounts that are associated with a customer account, though these terms can be used somewhat interchangeably depending upon the context of use. Cloud provider networks are sometimes “multi-tenant” as they can provide services to multiple different customers using the same physical computing infrastructure; for example, virtual machine instances may be concurrently hosted for different customers using a same underlying physical host computing device.

Users can interact with a cloud provider network 100 across one or more intermediate networks 140 (e.g., the internet) via one or more interface(s) 102, such as through use of application programming interface (API) calls, via a console implemented as a website or application, etc. An API refers to an interface and/or communication protocol between a client and a server, such that if the client makes a request in a predefined format, the client should receive a response in a specific format or initiate a defined action. In the cloud provider network context, APIs provide a gateway for customers to access cloud infrastructure by allowing customers to obtain data from or cause actions within the cloud provider network, enabling the development of applications that interact with resources and services hosted in the cloud provider network. APIs can also enable different services of the cloud provider network to exchange data with one another. The interface(s) can be part of, or serve as a front-end to, a control plane of the cloud provider network 100 that includes “backend” services supporting and enabling the services that can be more directly offered to customers.

Thus, a cloud provider network (or just “cloud”) typically refers to a large pool of accessible virtualized computing resources (such as compute, storage, and networking resources, applications, and services). A cloud can provide convenient, on-demand network access to a shared pool of configurable computing resources that can be programmatically provisioned and released in response to customer commands. These resources can be dynamically provisioned and reconfigured to adjust to variable load. Cloud computing can thus be considered as both the applications delivered as services over a publicly accessible network (e.g., the Internet, a cellular communication network) and the hardware and software in cloud provider data centers that provide those services.

To provide these and other computing resource services, cloud provider networks 100 often rely upon virtualization techniques. For example, virtualization technologies can provide users the ability to control or use compute resources (e.g., an “instance,” such as a VM using a guest operating system (O/S) that operates using a hypervisor that might or might not further operate on top of an underlying host O/S, a container that might or might not operate in a VM, a compute instance that can execute on “bare metal” hardware without an underlying hypervisor), where one or multiple compute resources can be implemented using a single electronic device. Thus, a user can directly use a compute resource (e.g., provided by a hardware virtualization service) hosted by the provider network to perform a variety of computing tasks. Additionally, or alternatively, a user can indirectly use a compute resource by submitting code to be executed by the provider network (e.g., via an on-demand code execution service), which in turn uses one or more compute resources to execute the code-typically without the user having any control of or knowledge of the underlying compute instance(s) involved.

As described herein, one type of service that a provider network may provide may be referred to as a “managed compute service” 106 that executes code or provides computing resources for its users in a managed configuration. Examples of managed compute services include, for example, a hardware virtualization service, a container service, or the like.

A hardware virtualization service (referred to in various implementations as an elastic compute service, a virtual machines service, a computing cloud service, a compute engine, or a cloud compute service) can enable users of the cloud provider network 100 to provision and manage compute resources such as virtual machine instances. Virtual machine technology can use one physical server to run the equivalent of many servers (each of which is called a virtual machine), for example using a hypervisor, which can run at least partly on an offload card of the server (e.g., a card connected via PCI or PCIe to the physical CPUs) and other components of the virtualization host can be used for some virtualization management components. Such an offload card of the host can include one or more CPUs that are not available to user instances, but rather are dedicated to instance management tasks such as virtual machine management (e.g., a hypervisor), input/output virtualization to network-attached storage volumes, local migration management tasks, instance health monitoring, and the like). Virtual machines are commonly referred to as compute instances or simply “instances.” As used herein, provisioning a virtual compute instance generally includes reserving resources (e.g., computational and memory resources) of an underlying physical compute instance for the client (e.g., from a pool of available physical compute instances and other resources), installing or launching required software (e.g., an operating system), and making the virtual compute instance available to the client for performing tasks specified by the client.

Another type of managed compute service can be a container service, such as a container orchestration and management service (referred to in various implementations as a container service, cloud container service, container engine, or container cloud service) that allows users of the cloud provider network to instantiate and manage containers. In some examples the container service can be a Kubernetes-based container orchestration and management service (referred to in various implementations as a container service for Kubernetes, Azure Kubernetes service, IBM cloud Kubernetes service, Kubernetes engine, or container engine for Kubernetes). A container, as referred to herein, packages up code and all its dependencies so an application (also referred to as a task, pod, or cluster in various container services) can run quickly and reliably from one computing environment to another. A container image is a standalone, executable package of software that includes everything needed to run an application process: code, runtime, system tools, system libraries and settings. Container images become containers at runtime. Containers are thus an abstraction of the application layer (meaning that each container simulates a different software application process). Though each container runs isolated processes, multiple containers can share a common operating system, for example by being launched within the same virtual machine. In contrast, virtual machines are an abstraction of the hardware layer (meaning that each virtual machine simulates a physical machine that can run software). While multiple virtual machines can run on one physical machine, each virtual machine typically has its own copy of an operating system, as well as the applications and their related files, libraries, and dependencies. Some containers can be run on instances that are running a container agent, and some containers can be run on bare-metal servers, or on an offload card of a server.

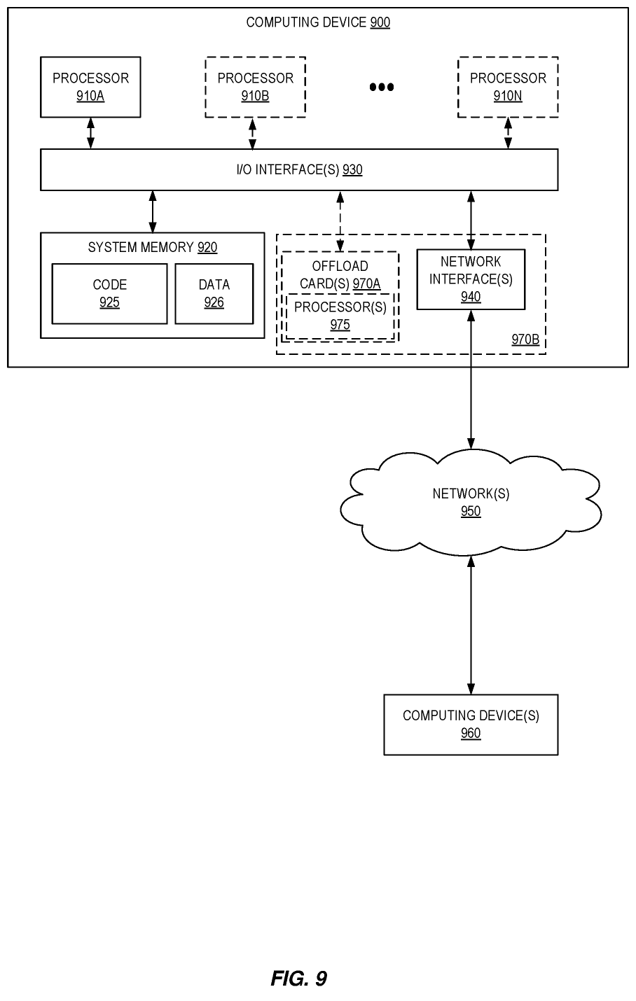

Typically, a fleet of host computer systems 120A-120N provides the resources supporting the virtualized environments provided by the managed compute service. An exemplary computer system is illustrated in FIG. 9. Host computer systems 120 may have different hardware and/or software configurations to provide support for different customer workload types or demands. In addition to executing software in the virtualized guest environments, the host computer systems execute other software applications to support resource virtualization and host management. For example, the host computer system 120A executes instance(s) 125A-125N (referred to collectively as instances 125) along with several other software components including an update agent 121, a notification agent 122, an instance manager 123 such as a virtual machine or container manager, a metadata agent 124, and other host software 126 (such as device emulators, device virtualization software, device drivers, firmware, an operating system, etc.).

Instances 125 are the virtualized environments that execute software applications, sometimes referred to as “guest” environments and “guest” software applications, respectively. The applications executed across different instanced environments are generally isolated from one another and have a limited access to the resources of the host computer system controlled by the virtualization technology (e.g., containers, instances, or the like).

The instance manager 123 facilitates the allocation of the resources of the host computer system 120A amongst hosted instances 125. Such resources typically include the physical resources of the host, such as processors, memory devices, network adapters, and storage devices. The instance manager 123 may be a virtual machine manager, container manager, container orchestrator, or similar that manages the instance lifecycle from beginning (e.g., launch, containerization, etc.) to end (e.g., termination, stopping, etc.). The instance manager 123 can allocate (or otherwise limit to) some portion of the underlying host computer system 120 resources to each instance 125.

Maintaining the fleet of hosts 120 is a continuous effort. Besides pulling hosts out of the available pool for offline maintenance, a deployment service 104 can push updates to the various cloud-managed (e.g., outside of the customer or guest environment) software applications executing on the hosts such as the host software 126 (such as device drivers, firmware, software enabling resource virtualization, etc.) as well as the other illustrated components (the update agent 121, the notification agent 122, the instance manager 123, and the metadata agent 124). Such updates that are deployed to hosts executing instances are sometimes called “live updates.” In some cases, these live updates are benign, with the hosted instance(s) 125 experiencing no negative effects from the update process. In other cases, such as updating software providing virtualization of a host hardware resource or other software component that is part of the virtualization stack, live updates may impact observable performance.

The update agent 121, the notification agent 122, and the metadata agent 124 operate to provide notices of host software updates to instances 125 and to apply those updates. The operation and relation of these components, like others, is presented herein as an example of how to notify virtualization guests of upcoming host software updates. Based on the disclosure and teachings provided herein, a person of ordinary skill in the art will appreciate other ways and/or methods to implement other examples without departing from the teachings disclosed herein.

In some examples, the update agent 121 receives and applies host software updates under the direction of the deployment service 104. The deployment service can send software updates (e.g., as packages, kegs, tars, or other software distribution form) to the update agent 121, and the update agent 121 can apply updates, typically by replacing or modifying files, executables, etc. included with the received software update and terminating and restarting the associated process. Other software update techniques will be appreciated by those who have skill in the art. In any event, during an update, instances 125 may see a momentary performance impact when using any resources provided or otherwise managed by that host software application being updated. The update can be considered to cause a “performance-impacting event” or “performance event.”

To provide instances 125 notice prior to applying an update, the update agent 121 can receive an instruction to apply an update and then delay for a period of time, generally at least the maximum notice period, until applying the update (the time at which an update is applied can be referred to as the “update time”). The maximum notice period represents the amount of time that should elapse after which a first or initial notice is sent to instances 125 and before applying the associated software update. For example, if notices of an upcoming host software update are made available to instances 125 one minute and ten minutes before the update is applied, the maximum notice period would be ten minutes.

In some examples, the notification agent 122 manages the sending of notifications regarding upcoming host software updates to the instances 125. In some examples, the notification agent 122 can send or otherwise make available a notification of an upcoming host software update to each of the instances 125 on the host computer system 120. For example, the notification agent 122 can provide notice to each instance 125 at the maximum notice time.

In some examples, the notification agent 122 can provide more than one notification to individual of instances 125. The notification agent 122 may be configured to provide an initial notification at the maximum notice time, and one or more additional notifications at times closer to the update time (e.g., an initial notification at ten minutes prior to the update time, a second notification at five minutes prior to the update time, and a final notification at one minute prior to the update time).

In some examples, the notification agent 122 can limit the instances 125 provided notifications based on factors such as which instances will be impacted by the upcoming host software update and/or which instances of customers who have requested their instances receive such notifications. For example, instance metadata (not shown) stored within the host environment 129 can include data such as instance-to-hardware mappings. Based on the physical resources that will be impacted by a software update, the notification agent 122 can determine which instances use the impacted resource(s) and only provide notifications to those instances. The instance metadata can also include whether hosted instances belong to customers that are to receive performance event notifications (e.g., in examples where customers can opt into or out of notifications). Using this notification “enable/disable” flag, the notification agent 122 can determine which instances are to receive notifications and only provide notifications to those instances.

In some examples, the metadata agent 124 provides notifications from the host environment 129 to the guest environments of instances 125. The metadata agent 124 can be a web server that can be targeted with a special network address by software applications executing in a guest environment. For example, the metadata agent 124 can respond to Hypertext Transfer Protocol (HTTP) requests from guest environment software applications targeting a link-local network address in the range of 169.254.0.0/16. The notification agent 122 can provide notifications to particular instances to the metadata agent 124, which in turn can provide the notifications in response to requests from the respective instances 125. Sockets can be used to differentiate amongst the instances 125 (e.g., a notification to be provided to the instance 125A can be associated with one socket associated with instance 125A, a notification to be provided to instance 125N can be associated with another socket of the instance 125N). In some examples, the request-response scheme described above can be reversed, with a guest software application addressable by the metadata agent 124 and listening for Hypertext Transfer Protocol (HTTP) requests.

Since software of the guest and host environments are processes executing on the same host computer system 120, various other inter-process communication (IPC) strategies can be used to convey notifications to the instances. For example, a portion of the memory space available to instances can be reserved for communication of notifications. A software application executing in the host environment such as the metadata agent 124 can write a notification for a particular instance to its corresponding reserved memory space, and a software application executing in the guest environment can read the notification from memory.

Other techniques to provide notifications from the host environment 129 to software applications executing in the guest environments will be appreciated by those who have skill in the art.

In some examples, the software application obtaining notifications in the guest environment can be an agent that is part of a software development kit, library, or other distribution provided by the operator of the cloud provider network. For example, the cloud provider network may provide development environments, toolkits, or other services that customers can use to make their instances performance-event aware (e.g., through function calls to the provided agent in the customer application).

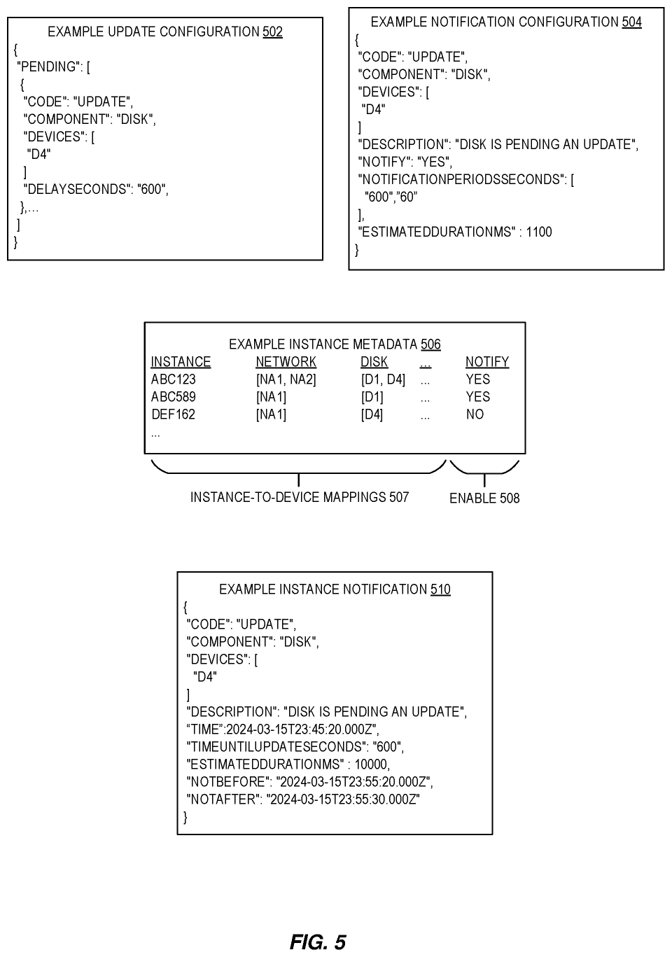

An exemplary set of operations is now described with reference to the encircled numbers (1) through (6). Reference is made to FIG. 5, which is a diagram illustrating various exemplary data structures according to some examples. Note that the numbering of the circles is not intended to impart an order of operations unless specifically set forth in the associated description.

At circle (1), the deployment service 104 sends the software update (e.g., as packages, kegs, tars, or other software distribution form) and update configuration data to the update agent 121. Exemplary update configuration data is shown in FIG. 5 as update configuration 502. The update configuration 502 includes an indication of the impacted physical resources (in this case disk device D4) as well as a delay (here, 600 seconds). In this example, the delay indicates how long the update agent 121 should wait after receiving an instruction to apply an update before applying it. The delay generally corresponds with the maximum notice period. Note that by sending the software update and later sending the instruction to apply the update, delays in transmitting the software update (e.g., due to network congestion or other factors) will not affect the ability of the update agent 121 to apply the update at a determined time.

At circle (2), the deployment service 104 sends notification configuration data to the notification agent 122. Exemplary notification configuration data is shown in FIG. 5 as notification configuration 504. The notification configuration 504 includes an indication of the impacted physical resources (in this case disk device D4) as well as the time(s) at which to provide notifications to instances 125 (here, 60 and 600 seconds prior to the update, with 600 being the maximum notice period). In some examples, the notification time(s) may be pre-loaded to the notification agent 122, and the update agent 121 can provide details regarding the specific update to the notification agent 122 based on the update configuration (e.g., which devices will be impacted by the update).

At circle (3), the deployment service 104 sends the update agent 121 an instruction to apply the software update. The update agent 121 delays execution of that instruction by the delay in the associated update configuration and signals the notification agent 122 of the impending update.

At circle (4), the notification agent 122 generates and provides notifications to the instances 125. The notification agent 122 can start various timers to track when to provide notifications. For example, with the 600 and 60 second notifications in the example notification configuration 504, the notification agent 122 can provide the 600 second notification upon receipt of the impending update from the update agent 121 and start a timer to provide the 60 second notification 540 seconds later.

An exemplary notification is shown in FIG. 5 as notification 510. The notification 510 can include details regarding the impacted component and devices (or device aliases in the guest environment), as well as timing information. The component or device identification can be useful in that some instances may be susceptible to performance events impacting certain devices and not others, allowing the guest software application to act (or not act) depending on the impacted resources. The timing information can be absolute and/or relative, with both shown in the example notification 510. For example, the notification can include the time until the update will be applied (e.g., the TIMEUNTILUPDATESECONDS) to indicate how long from the notice generation until the update will be applied. Such a relative time can be useful where the instances there is only a small delay between the generation of the notice and the receipt of the notice by an instance (e.g., such as when the instance has an outstanding “long-poll” request described in greater detail below). In other cases, such as where a guest software application periodically check for notices, the notification can include the absolute time of the software update (e.g., “NOTBEFORE”).

As indicated above, the notification agent 122 can filter the number of notifications by limiting notifications to those instances 125 impacted by the update and/or those instances that have been configured to receive performance event notifications. In this example with the update affecting disk D4, the notification agent 122 can send notifications only to those instances relying on disk D4. To make these determinations, the notification agent 122 can leverage instance metadata accessible within the host environment 129. Exemplary instance metadata is shown in FIG. 5 as instance metadata 506. As shown, instance metadata 506 can include instance-to-device mappings to track which instances are reliant on which devices of the underlying host computer system 120, as well as the enable 508, which may be set per the direction of a customer. In this example, with the software update affecting disk D4, the notification agent 122 can generate and provide notifications to instances “ABC123” and “DEF162” since they use disk D4.

At circle (5), the update agent 121 applies the software update after the configured delay, typically by replacing or modifying files, executables, etc. included with the received software update and terminating and restarting the associated process.

At circle (6), the managed compute service 106 receives an indication from a customer whether to provide performance event notifications to the customer's instances generally or to specific instances. The managed compute service 106 can update the associated instance metadata described above with the indication such as via the instance manager 123 (as shown) or the metadata agent 124 across the host computer system(s) 120 hosting the customer's (specific) instances.

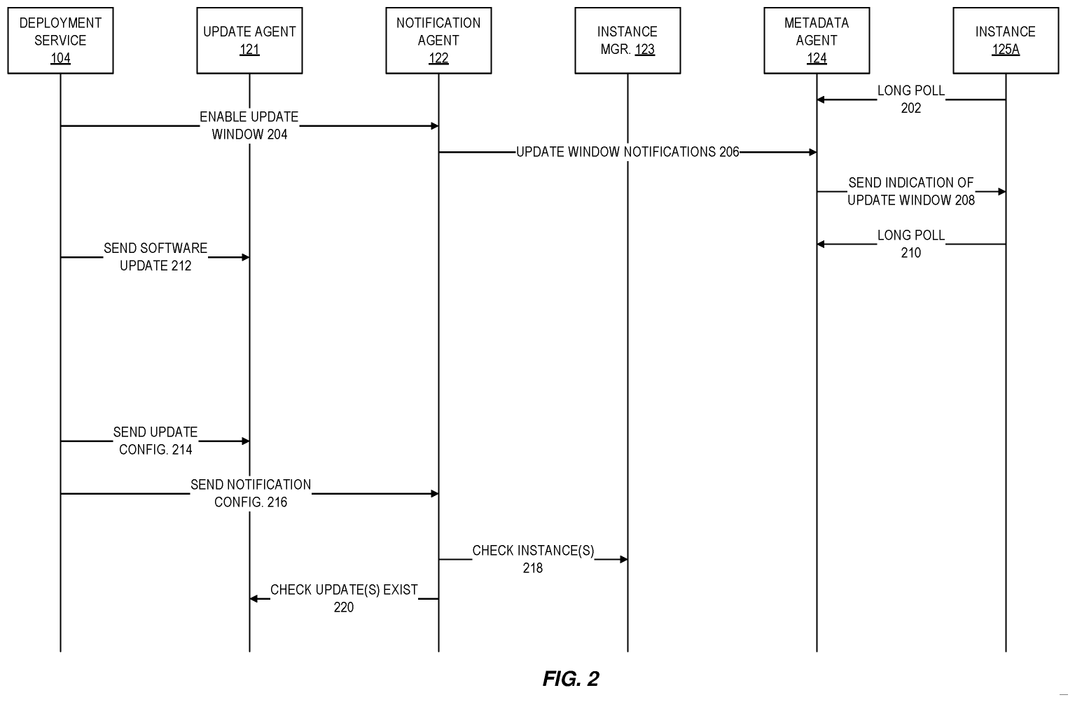

FIG. 2 is a sequence diagram illustrating exemplary operations to notify virtualization guests of upcoming host software updates according to some examples. At 202, a software application executed by the instance 125A (e.g., an application executing in a guest environment) sends a message requesting updates regarding performance events to the metadata agent 124. In this example, the request is treated as a “long poll” request, where the metadata agent 124 delays responding to the request until there is an update to provide. If there are no performance events or other related information to convey from the host environment, the metadata agent 124 will hold the request open. If the request times out from the perspective of the software application, the software application can re-issue another request and again the metadata agent 124 can defer a response event-related information is available. In other examples, the metadata agent 124 may provide a response including no notifications or other information related to performance events, and the software application can poll the metadata agent 124 for updates.

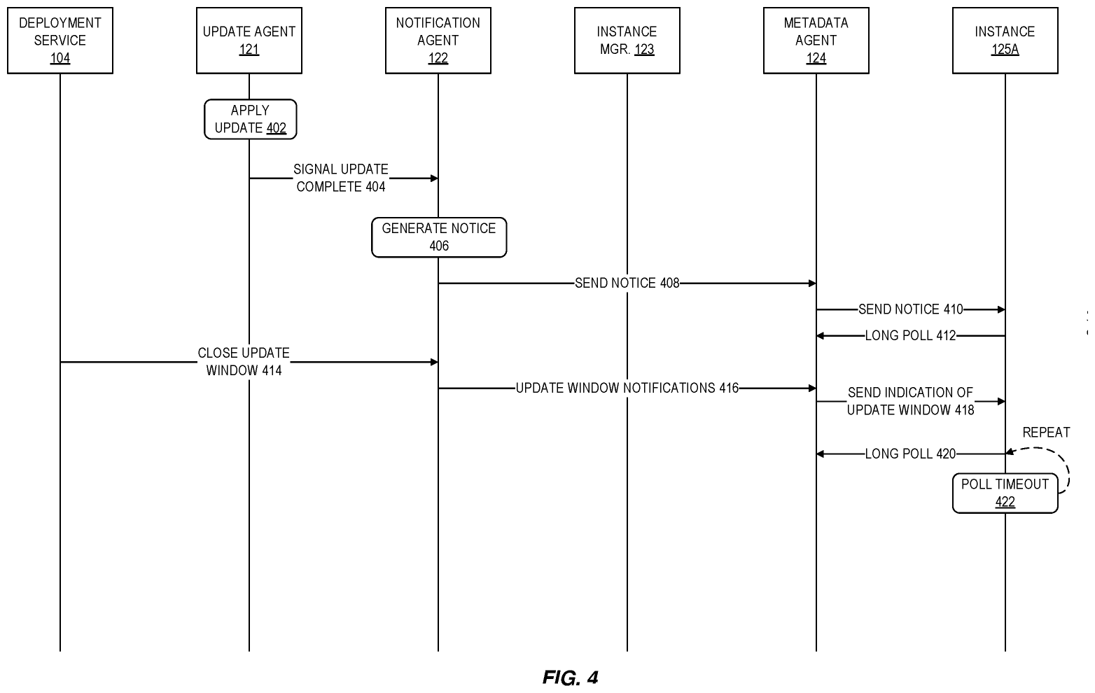

In some examples, guest environments can be provided with an indication of the opening and closing of an “update window,” or a period of time during which updates will be applied and may cause performance events. The deployment service 104 can send a message 204 indicating the opening of an update window to the notification agent 122. The notification agent 122 can then generate notifications 206 of the update window opening to the metadata agent 124, which in turn can send notifications 208 of the update window opening to the instance(s) 125 in response to a request such as request 202. Jumping ahead to FIG. 4, once the updates have been applied, the deployment service 104 can send a message closing the update window to the notification agent 122. The notification agent 122 can then generate notifications 416 of the update window closing to the metadata agent 124, which in turn can send notifications 418 of the update window closing to the instance(s) 125 in response to a request such as request 412.

Returning to FIG. 2, at 212, the deployment service 104 can send a host software application update to the update agent 121. Exemplary update forms include packages, kegs, tars, or other software distribution forms. At 214, the deployment service 104 can send the update configuration to the update agent 121 (e.g., the update configuration 502). At 216, the deployment service 104 can send the notification configuration to the notification agent 121 (e.g., the notification configuration 504). The notification agent 121 can perform various checks, such as checking whether impacted instances exist with the instance manager 123 at 218 and/or whether the update is queued with the update agent at 220. Failures can be reported back to the deployment service 104 (not shown).

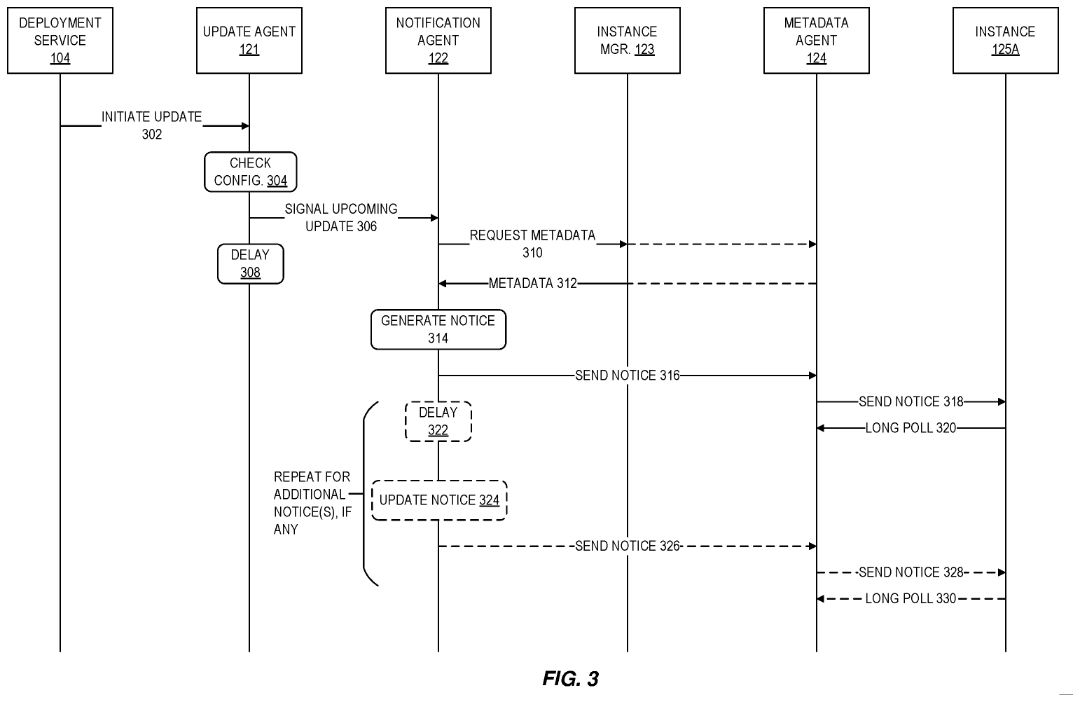

FIG. 3 is a sequence diagram illustrating exemplary operations continuing from FIG. 2 according to some examples. At 302, the deployment service 104 can send a message to the update agent 121 instructing it to apply the host software application update received at 212. At 304, the update agent 121 checks the update configuration to determine whether a delay is imposed (e.g., the “DELAYSECONDS” field in update configuration 502). Such a check can be used when some updates are benign (e.g., they do not cause performance events), allowing the update agent 121 to apply them without delaying for notification(s). At 306, assuming the update is associated with a performance event, the update agent 121 can signal the upcoming update to the notification agent 122. The update agent 121 can then delay application of the update until the delay time has lapsed (e.g., by tracking the “DELAYSECONDS” with a timer).

At 310 and 312, the notification agent 122 can obtain metadata, such as described above, about the hosted instances. Such metadata may be accessed directly or indirectly via a request to another application such as the instance manager 123 or metadata agent 124. At 314, the notification agent 122 generate notices for impacted instances. Here, the notification agent 122 can filter which notices are generated by determining which instances are reliant on the impacted physical resource and/or have been enabled to receive performance event notifications. At 316, assuming the instance 125A will be impacted, the notification agent 122 sends the generated notice to the metadata agent 124. At 318, the metadata agent 124 can provide the notification to the instance 125A, in this case in response to the request 210.

If multiple notifications are to be sent, the notification agent 122 can delay as indicated at 322 for some amount of time until the next notification is to be sent (e.g., if the first was sent at 600 seconds before the update time and the next is to be sent at 60 seconds before the update time, the notification agent 122 can delay sending the next notification for 540 seconds). At 324, the notification agent 122 can optionally update the previously generated notice (e.g., to update the “TIMEUNTILUPDATESECONDS”) and send the notification to the metadata agent 124, which in turn can provide the notification to the instance 124A at 326, in this case in response to the request 320 sent by the instance 125A. The operations 322, 324, and 326 can be repeated as indicated for the additional notice(s).

FIG. 4 is a sequence diagram illustrating exemplary operations continuing from FIG. 3 according to some examples. At 402, after the delay has elapsed, the update agent 121 can apply the update (e.g., by modifying or replacing files, restarting a process, etc.). At 404, the update agent 121 can signal the completion of the update to the notification agent 122. At 406, the notification agent 122 can generate notices for the instances that were impacted by the update, these notifications to indicate that the update has been completed. At 408, the notification agent 122 sends the generated update completion notices to the metadata agent 124. At 410, the metadata agent 124 can provide the update completion notifications to the impacted instances, such as the instance 125A, in this case in response to the last request (e.g., 320 or 330).

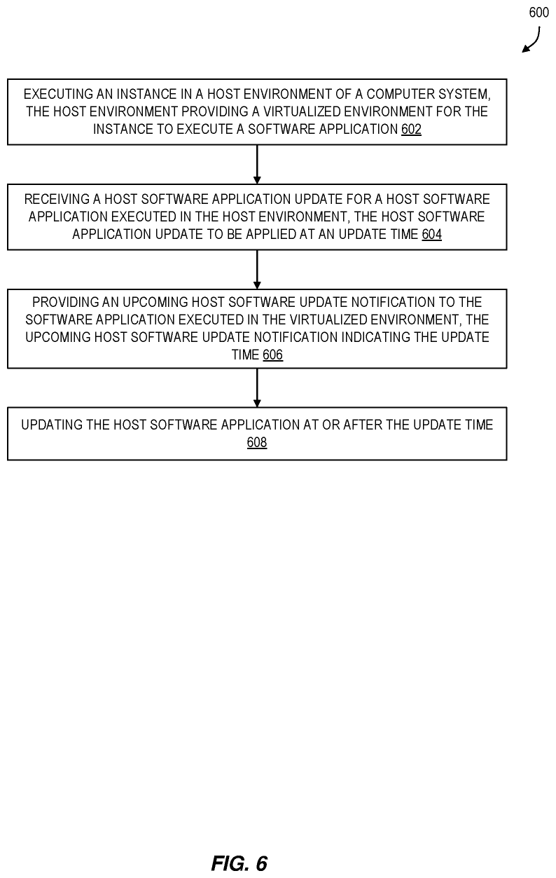

FIG. 6 is a flow diagram illustrating operations 600 of a method for notifying virtualization guests of upcoming host software updates according to some examples. Some or all of the operations 600 (or other processes described herein, or variations, and/or combinations thereof) are performed under the control of one or more computing devices configured with executable instructions, and are implemented as code (e.g., executable instructions, one or more computer programs, or one or more applications) executing collectively on one or more processors. The code is stored on a computer-readable storage medium, for example, in the form of a computer program comprising instructions executable by one or more processors. The computer-readable storage medium is non-transitory. In some examples, one or more (or all) of the operations 600 are performed by a host computer system 120 of the other figures.

The operations 600 include, at block 602, executing an instance in a host environment of a computer system, the host environment providing a virtualized environment for the instance to execute a software application. The operations 600 further include, at block 604, receiving a host software application update for a host software application executed in the host environment, the host software application update to be applied at an update time. The operations 600 further include, at block 606, providing an upcoming host software update notification to the software application executed in the virtualized environment, the upcoming host software update notification indicating the update time. The operations 600 further include, at block 608, updating the host software application at or after the update time.

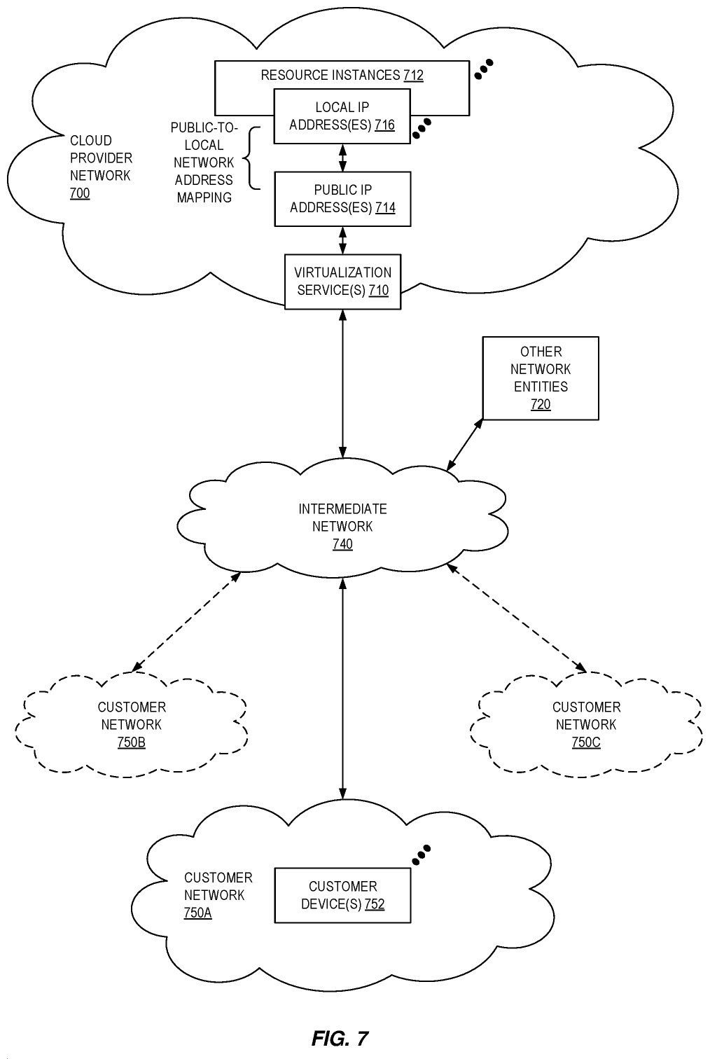

FIG. 7 illustrates an example provider network (or “service provider system”) environment according to some examples. A provider network 700 can provide resource virtualization to customers via one or more virtualization services 710 that allow customers to purchase, rent, or otherwise obtain instances 712 of virtualized resources, including but not limited to computation and storage resources, implemented on devices within the provider network or networks in one or more data centers. Local Internet Protocol (IP) addresses 716 can be associated with the resource instances 712; the local IP addresses are the internal network addresses of the resource instances 712 on the provider network 700. In some examples, the provider network 700 can also provide public IP addresses 714 and/or public IP address ranges (e.g., Internet Protocol version 4 (IPv4) or Internet Protocol version 6 (IPv6) addresses) that customers can obtain from the provider 700.

Conventionally, the provider network 700, via the virtualization services 710, can allow a customer of the service provider (e.g., a customer that operates one or more customer networks 750A-750C (or “client networks”) including one or more customer device(s) 752) to dynamically associate at least some public IP addresses 714 assigned or allocated to the customer with particular resource instances 712 assigned to the customer. The provider network 700 can also allow the customer to remap a public IP address 714, previously mapped to one virtualized computing resource instance 712 allocated to the customer, to another virtualized computing resource instance 712 that is also allocated to the customer. Using the virtualized computing resource instances 712 and public IP addresses 714 provided by the service provider, a customer of the service provider such as the operator of the customer network(s) 750A-750C can, for example, implement customer-specific applications and present the customer's applications on an intermediate network 740, such as the Internet. Other network entities 720 on the intermediate network 740 can then generate traffic to a destination public IP address 714 published by the customer network(s) 750A-750C; the traffic is routed to the service provider data center, and at the data center is routed, via a network substrate, to the local IP address 716 of the virtualized computing resource instance 712 currently mapped to the destination public IP address 714. Similarly, response traffic from the virtualized computing resource instance 712 can be routed via the network substrate back onto the intermediate network 740 to the source entity 720.

Local IP addresses, as used herein, refer to the internal or “private” network addresses, for example, of resource instances in a provider network. Local IP addresses can be within address blocks reserved by Internet Engineering Task Force (IETF) Request for Comments (RFC) 1918 and/or of an address format specified by IETF RFC 4193 and can be mutable within the provider network. Network traffic originating outside the provider network is not directly routed to local IP addresses; instead, the traffic uses public IP addresses that are mapped to the local IP addresses of the resource instances. The provider network can include networking devices or appliances that provide network address translation (NAT) or similar functionality to perform the mapping from public IP addresses to local IP addresses and vice versa.

Public IP addresses are Internet mutable network addresses that are assigned to resource instances, either by the service provider or by the customer. Traffic routed to a public IP address is translated, for example via 1:1 NAT, and forwarded to the respective local IP address of a resource instance.

Some public IP addresses can be assigned by the provider network infrastructure to particular resource instances; these public IP addresses can be referred to as standard public IP addresses, or simply standard IP addresses. In some examples, the mapping of a standard IP address to a local IP address of a resource instance is the default launch configuration for all resource instance types.

At least some public IP addresses can be allocated to or obtained by customers of the provider network 700; a customer can then assign their allocated public IP addresses to particular resource instances allocated to the customer. These public IP addresses can be referred to as customer public IP addresses, or simply customer IP addresses. Instead of being assigned by the provider network 700 to resource instances as in the case of standard IP addresses, customer IP addresses can be assigned to resource instances by the customers, for example via an API provided by the service provider. Unlike standard IP addresses, customer IP addresses are allocated to customer accounts and can be remapped to other resource instances by the respective customers as necessary or desired. A customer IP address is associated with a customer's account, not a particular resource instance, and the customer controls that IP address until the customer chooses to release it. Unlike conventional static IP addresses, customer IP addresses allow the customer to mask resource instance or availability zone failures by remapping the customer's public IP addresses to any resource instance associated with the customer's account. The customer IP addresses, for example, enable a customer to engineer around problems with the customer's resource instances or software by remapping customer IP addresses to replacement resource instances.

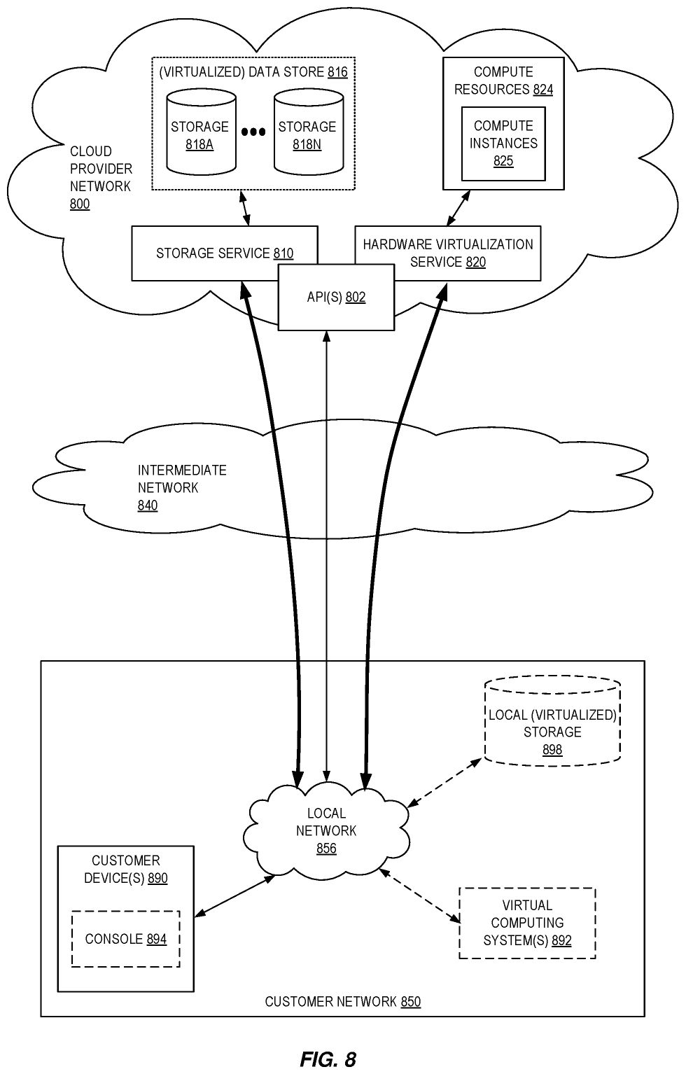

FIG. 8 is a block diagram of an example provider network environment that provides a storage service and a hardware virtualization service to customers, according to some examples. A hardware virtualization service 820 provides multiple compute resources 824 (e.g., compute instances 825, such as VMs) to customers. The compute resources 824 can, for example, be provided as a service to customers of a provider network 800 (e.g., to a customer that implements a customer network 850). Each computation resource 824 can be provided with one or more local IP addresses. The provider network 800 can be configured to route packets from the local IP addresses of the compute resources 824 to public Internet destinations, and from public Internet sources to the local IP addresses of the compute resources 824.

The provider network 800 can provide the customer network 850, for example coupled to an intermediate network 840 via a local network 856, the ability to implement virtual computing systems 892 via the hardware virtualization service 820 coupled to the intermediate network 840 and to the provider network 800. In some examples, the hardware virtualization service 820 can provide one or more APIs 802, for example a web services interface, via which the customer network 850 can access functionality provided by the hardware virtualization service 820, for example via a console 894 (e.g., a web-based application, standalone application, mobile application, etc.) of a customer device 890. In some examples, at the provider network 800, each virtual computing system 892 at the customer network 850 can correspond to a computation resource 824 that is leased, rented, or otherwise provided to the customer network 850.

From an instance of the virtual computing system(s) 892 and/or another customer device 890 (e.g., via console 894), the customer can access the functionality of a storage service 810, for example via the one or more APIs 802, to access data from and store data to storage resources 818A-818N of a virtual data store 816 (e.g., a folder or “bucket,” a virtualized volume, a database, etc.) provided by the provider network 800. In some examples, a virtualized data store gateway (not shown) can be provided at the customer network 850 that can locally cache at least some data, for example frequently accessed or critical data, and that can communicate with the storage service 810 via one or more communications channels to upload new or modified data from a local cache so that the primary store of data (the virtualized data store 816) is maintained. In some examples, a user, via the virtual computing system 892 and/or another customer device 890, can mount and access virtual data store 816 volumes via the storage service 810 acting as a storage virtualization service, and these volumes can appear to the user as local (virtualized) storage 898.

While not shown in FIG. 8, the virtualization service(s) can also be accessed from resource instances within the provider network 800 via the API(s) 802. For example, a customer, appliance service provider, or other entity can access a virtualization service from within a respective virtual network on the provider network 800 via the API(s) 802 to request allocation of one or more resource instances within the virtual network or within another virtual network.

### Illustrative Systems

In some examples, a system that implements a portion or all of the techniques described herein can include a general-purpose computer system, such as the computing device 900 (also referred to as a computing system or electronic device) illustrated in FIG. 9, that includes, or is configured to access, one or more computer-accessible media. In the illustrated example, the computing device 900 includes one or more processors 910 coupled to a system memory 920 via an input/output (I/O) interface 930. The computing device 900 further includes a network interface 940 coupled to the I/O interface 930. While FIG. 9 shows the computing device 900 as a single computing device, in various examples the computing device 900 can include one computing device or any number of computing devices configured to work together as a single computing device 900.

In various examples, the computing device 900 can be a uniprocessor system including one processor 910, or a multiprocessor system including several processors 910 (e.g., two, four, eight, or another suitable number). The processor(s) 910 can be any suitable processor(s) capable of executing instructions. For example, in various examples, the processor(s) 910 can be general-purpose or embedded processors implementing any of a variety of instruction set architectures (ISAs), such as the ×86, ARM, PowerPC, SPARC, or MIPS ISAs, or any other suitable ISA. In multiprocessor systems, each of the processors 910 can commonly, but not necessarily, implement the same ISA.

The system memory 920 can store instructions and data accessible by the processor(s) 910. In various examples, the system memory 920 can be implemented using any suitable memory technology, such as random-access memory (RAM), static RAM (SRAM), synchronous dynamic RAM (SDRAM), nonvolatile/Flash-type memory, or any other type of memory. In the illustrated example, program instructions and data implementing one or more desired functions, such as those methods, techniques, and data described above, are shown stored within the system memory 920 as code 925 (e.g., executable to implement, in whole or in part, the deployment service 104 or the software applications of a host computer system such as those illustrated in host 120A of FIG. 1) and data 926.

In some examples, the I/O interface 930 can be configured to coordinate I/O traffic between the processor 910, the system memory 920, and any peripheral devices in the device, including the network interface 940 and/or other peripheral interfaces (not shown). In some examples, the I/O interface 930 can perform any necessary protocol, timing, or other data transformations to convert data signals from one component (e.g., the system memory 920) into a format suitable for use by another component (e.g., the processor 910). In some examples, the I/O interface 930 can include support for devices attached through various types of peripheral buses, such as a variant of the Peripheral Component Interconnect (PCI) bus standard or the Universal Serial Bus (USB) standard, for example. In some examples, the function of the I/O interface 930 can be split into two or more separate components, such as a north bridge and a south bridge, for example. Also, in some examples, some or all of the functionality of the I/O interface 930, such as an interface to the system memory 920, can be incorporated directly into the processor 910.

The network interface 940 can be configured to allow data to be exchanged between the computing device 900 and other computing devices 960 attached to a network or networks 950, such as other computer systems or devices as illustrated in FIG. 1, for example. In various examples, the network interface 940 can support communication via any suitable wired or wireless general data networks, such as types of Ethernet network, for example. Additionally, the network interface 940 can support communication via telecommunications/telephony networks, such as analog voice networks or digital fiber communications networks, via storage area networks (SANs), such as Fibre Channel SANs, and/or via any other suitable type of network and/or protocol.

In some examples, the computing device 900 includes one or more offload cards 970A or 970B (including one or more processors 975, and possibly including the one or more network interfaces 940) that are connected using the I/O interface 930 (e.g., a bus implementing a version of the Peripheral Component Interconnect-Express (PCI-E) standard, or another interconnect such as a QuickPath interconnect (QPI) or UltraPath interconnect (UPI)). For example, in some examples the computing device 900 can act as a host electronic device (e.g., operating as part of a hardware virtualization service) that hosts compute resources such as compute instances, and the one or more offload cards 970A or 970B execute a virtualization manager that can manage compute instances that execute on the host electronic device. As an example, in some examples the offload card(s) 970A or 970B can perform compute instance management operations, such as pausing and/or un-pausing compute instances, launching and/or terminating compute instances, performing memory transfer/copying operations, etc. These management operations can, in some examples, be performed by the offload card(s) 970A or 970B in coordination with a hypervisor (e.g., upon a request from a hypervisor) that is executed by the other processors 910A-910N of the computing device 900. However, in some examples the virtualization manager implemented by the offload card(s) 970A or 970B can accommodate requests from other entities (e.g., from compute instances themselves), and cannot coordinate with (or service) any separate hypervisor.

In some examples, the system memory 920 can be one example of a computer-accessible medium configured to store program instructions and data as described above. However, in other examples, program instructions and/or data can be received, sent, or stored upon different types of computer-accessible media. Generally speaking, a computer-accessible medium can include any non-transitory storage media or memory media such as magnetic or optical media, e.g., disk or DVD/CD coupled to the computing device 900 via the I/O interface 930. A non-transitory computer-accessible storage medium can also include any volatile or non-volatile media such as RAM (e.g., SDRAM, double data rate (DDR) SDRAM, SRAM, etc.), read only memory (ROM), etc., that can be included in some examples of the computing device 900 as the system memory 920 or another type of memory. Further, a computer-accessible medium can include transmission media or signals such as electrical, electromagnetic, or digital signals, conveyed via a communication medium such as a network and/or a wireless link, such as can be implemented via the network interface 940.

Various examples discussed or suggested herein can be implemented in a wide variety of operating environments, which in some cases can include one or more user computers, computing devices, or processing devices which can be used to operate any of a number of applications. User or client devices can include any of a number of general-purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and/or other devices capable of communicating via a network.

Most examples use at least one network that would be familiar to those skilled in the art for supporting communications using any of a variety of widely-available protocols, such as Transmission Control Protocol/Internet Protocol (TCP/IP), File Transfer Protocol (FTP), Universal Plug and Play (UPnP), Network File System (NFS), Common Internet File System (CIFS), Extensible Messaging and Presence Protocol (XMPP), AppleTalk, etc. The network(s) can include, for example, a local area network (LAN), a wide-area network (WAN), a virtual private network (VPN), the Internet, an intranet, an extranet, a public switched telephone network (PSTN), an infrared network, a wireless network, and any combination thereof.

In examples using a web server, the web server can run any of a variety of server or mid-tier applications, including HTTP servers, File Transfer Protocol (FTP) servers, Common Gateway Interface (CGI) servers, data servers, Java servers, business application servers, etc. The server(s) also can be capable of executing programs or scripts in response requests from user devices, such as by executing one or more Web applications that can be implemented as one or more scripts or programs written in any programming language, such as Java®, C, C# or C++, or any scripting language, such as Perl, Python, PHP, or TCL, as well as combinations thereof. The server(s) can also include database servers, including without limitation those commercially available from Oracle (R), Microsoft (R), Sybase (R), IBM (R), etc. The database servers can be relational or non-relational (e.g., “NoSQL”), distributed or non-distributed, etc.

Environments disclosed herein can include a variety of data stores and other memory and storage media as discussed above. These can reside in a variety of locations, such as on a storage medium local to (and/or resident in) one or more of the computers or remote from any or all of the computers across the network. In a particular set of examples, the information can reside in a storage-area network (SAN) familiar to those skilled in the art. Similarly, any necessary files for performing the functions attributed to the computers, servers, or other network devices can be stored locally and/or remotely, as appropriate. Where a system includes computerized devices, each such device can include hardware elements that can be electrically coupled via a bus, the elements including, for example, at least one central processing unit (CPU), at least one input device (e.g., a mouse, keyboard, controller, touch screen, or keypad), and/or at least one output device (e.g., a display device, printer, or speaker). Such a system can also include one or more storage devices, such as disk drives, optical storage devices, and solid-state storage devices such as random-access memory (RAM) or read-only memory (ROM), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or web browser. It should be appreciated that alternate examples can have numerous variations from that described above. For example, customized hardware might also be used and/or particular elements might be implemented in hardware, software (including portable software, such as applets), or both. Further, connection to other computing devices such as network input/output devices can be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (EEPROM), flash memory or other memory technology, Compact Disc-Read Only Memory (CD-ROM), Digital Versatile Disk (DVD) or other optical storage, magnetic cassettes, magnetic tape, magnetic disk storage or other magnetic storage devices, or any other medium which can be used to store the desired information and which can be accessed by a system device. Based on the disclosure and teachings provided herein, a person of ordinary skill in the art will appreciate other ways and/or methods to implement the various examples.

In the preceding description, various examples are described. For purposes of explanation, specific configurations and details are set forth in order to provide a thorough understanding of the examples. However, it will also be apparent to one skilled in the art that the examples can be practiced without the specific details. Furthermore, well-known features can be omitted or simplified in order not to obscure the example being described.

Bracketed text and blocks with dashed borders (e.g., large dashes, small dashes, dot-dash, and dots) are used herein to illustrate optional aspects that add additional features to some examples. However, such notation should not be taken to mean that these are the only options or optional operations, and/or that blocks with solid borders are not optional in certain examples.

Reference numerals with suffix letters (e.g., 818A-818N) can be used to indicate that there can be one or multiple instances of the referenced entity in various examples, and when there are multiple instances, each does not need to be identical but may instead share some general traits or act in common ways. Further, the particular suffixes used are not meant to imply that a particular amount of the entity exists unless specifically indicated to the contrary. Thus, two entities using the same or different suffix letters might or might not have the same number of instances in various examples.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” is intended to be understood to mean either A, B, or C, or any combination thereof (e.g., A, B, and/or C). Similarly, language such as “at least one or more of A, B, and C” (or “one or more of A, B, and C”) is intended to be understood to mean A, B, or C, or any combination thereof (e.g., A, B, and/or C). As such, disjunctive language is not intended to, nor should it be understood to, imply that a given example requires at least one of A, at least one of B, and at least one of C to each be present.

As used herein, the term “based on” (or similar) is an open-ended term used to describe one or more factors that affect a determination or other action. It is to be understood that this term does not foreclose additional factors that may affect a determination or action. For example, a determination may be solely based on the factor(s) listed or based on the factor(s) and one or more additional factors. Thus, if an action A is “based on” B, it is to be understood that B is one factor that affects action A, but this does not foreclose the action from also being based on one or multiple other factors, such as factor C. However, in some instances, action A may be based entirely on B.

Unless otherwise explicitly stated, articles such as “a” or “an” should generally be interpreted to include one or multiple described items. Accordingly, phrases such as “a device configured to” or “a computing device” are intended to include one or multiple recited devices. Such one or more recited devices can be collectively configured to carry out the stated operations. For example, “a processor configured to carry out operations A, B, and C” can include a first processor configured to carry out operation A working in conjunction with a second processor configured to carry out operations B and C.

Further, the words “may” or “can” are used in a permissive sense (i.e., meaning having the potential to), rather than the mandatory sense (i.e., meaning must). The words “include,” “including,” and “includes” are used to indicate open-ended relationships and therefore mean including, but not limited to. Similarly, the words “have,” “having,” and “has” also indicate open-ended relationships, and thus mean having, but not limited to. The terms “first,” “second,” “third,” and so forth as used herein are used as labels for the nouns that they precede, and do not imply any type of ordering (e.g., spatial, temporal, logical, etc.) unless such an ordering is otherwise explicitly indicated. Similarly, the values of such numeric labels are generally not used to indicate a required amount of a particular noun in the claims recited herein, and thus a “fifth” element generally does not imply the existence of four other elements unless those elements are explicitly included in the claim or it is otherwise made abundantly clear that they exist.

The specification and drawings are, accordingly, to be regarded in an illustrative rather than a restrictive sense. It will, however, be evident that various modifications and changes can be made thereunto without departing from the broader scope of the disclosure as set forth in the claims.

What is claimed is:

1. A computer-implemented method comprising:
executing an instance in a host environment of a computer system of a cloud provider network, the host environment providing a virtualized environment for the instance to execute a guest software application;
receiving an instruction to apply, at an update time, an update to a host software application executing in the host environment, wherein the host software application shares a hardware device of the computer system amongst a plurality of instances including the instance;
determining that the instance uses the hardware device;
providing an upcoming host software update notification to the guest software application executed in the virtualized environment, the notification indicating the update time; and
updating the host software application at or after the update time.

2. The computer-implemented method of claim 1, wherein the notification is one of multiple notifications of the upcoming host software application update sent to the guest software application, each notification sent at a different time before the update time.

3. The computer-implemented method of claim 2, further comprising receiving indications of when to send the multiple notifications relative to the update time.

4. A computer-implemented method comprising:
executing an instance in a host environment of a computer system, the host environment providing a virtualized environment for the instance to execute a software application;
receiving a host software application update for a host software application executed in the host environment, the host software application update to be applied at an update time;
providing an upcoming host software update notification to the software application executed in the virtualized environment, the upcoming host software update notification indicating the update time; and
updating the host software application at or after the update time.

5. The computer-implemented method of claim 4, wherein the upcoming host software update notification is one of multiple upcoming host software update notifications provided to the software application executed in the virtualized environment, each notification sent at a different time before the update time.

6. The computer-implemented method of claim 5, further comprising receiving an indication of when to provide the multiple upcoming host software update notifications relative to the update time.

7. The computer-implemented method of claim 4, further comprising:
receiving an indication of an amount of time to delay application of the host software application update after receiving an instruction to apply the host software application update;
receiving the instruction to apply the host software application update; and
delaying application of the host software application update until the update time.

8. The computer-implemented method of claim 4, wherein the upcoming host software update notification provides an amount of time prior to the update time or a time at or after which the host software application update will be applied.

9. The computer-implemented method of claim 4, further comprising:
receiving, by a service of a cloud provider network that manages virtualization of the computer system, a customer request to enable receipt of performance event notifications by the instance, wherein the host software application update is associated with a performance event; and
determining, prior to providing the upcoming host software update notification, that performance event notifications for the instance are enabled.

10. The computer-implemented method of claim 4, further comprising:
receiving, by an application executed in the host environment, a request for performance events from the software application executed in the virtualized environment; and
sending, from the application executed in the host environment, the upcoming host software update notification of the host software application update to the software application executed in the virtualized environment in response to the request.

11. The computer-implemented method of claim 10, wherein the application executed in the host environment is a metadata web server, and wherein the request for performance events is a Hypertext Transfer Protocol request.

12. The computer-implemented method of claim 10, wherein the request is received prior to receiving the host software application update and further comprising delaying providing a response to the request at least until after receiving the host software application update.

13. The computer-implemented method of claim 4, wherein providing the upcoming host software update notification includes writing to a portion of memory of the computer system allocated to the virtualized environment.

14. The computer-implemented method of claim 4, wherein the host software application is virtualization software of a physical resource of the computer system, and wherein the physical resource is at least one of a processor, a memory device, a network adapter, or a storage device.

15. The computer-implemented method of claim 14, further comprising determining, prior to sending the upcoming host software update notification, that the instance uses the physical resource.

16. A system comprising:
a computer system of a cloud provider network, the computer system including instructions that upon execution cause the computer system to:
execute an instance in a host environment of a computer system, the host environment providing a virtualized environment for the instance to execute a software application;
receive a host software application update for a host software application executed in the host environment, the host software application update to be applied at an update time;
provide an upcoming host software update notification to the software application executed in the virtualized environment, the upcoming host software update notification indicating the update time; and
update the host software application at or after the update time;
a second one or more computing devices to implement a deployment service in the cloud provider network, the deployment service including instructions that upon execution cause the deployment service to:
send, to the computer system, the host software application update.

17. The system of claim 16, wherein the upcoming host software update notification is one of multiple upcoming host software update notifications provided to the software application executed in the virtualized environment, each notification sent at a different time before the update time.

18. The system of claim 17, wherein the computer system includes further instructions that upon execution cause the computer system to receive an indication of when to provide the multiple upcoming host software update notifications relative to the update time.

19. The system of claim 16, wherein the computer system includes further instructions that upon execution cause the computer system to:
receive an indication of an amount of time to delay application of the host software application update after receiving an instruction to apply the host software application update;
receive the instruction to apply the host software application update; and
delay application of the host software application update until the update time.

20. The system of claim 16, wherein the upcoming host software update notification provides an amount of time prior to the update time or a time at or after which the host software application update will be applied.
